(19) United States
(12) Patent Application Publication
(10) Pub. No.: US 2014/0293481 A1
(43) Pub. Date: Oct. 2, 2014

(54) HARD DISK DRIVE

(71) Applicant: SAMSUNG ELECTRO-MECHANICS CO., LTD., Suwon (KR)

(72) Inventor: Nam Ki Park, Suwon (KR)

(21) Appl. No.: 13/938,162

(22) Filed: Jul. 9, 2013

(30) Foreign Application Priority Data
Mar. 26, 2013 (KR) 10-2013-0032154

(51) Int. Cl. G11B 33/02

(52) U.S. Cl. CPC G11B 33/02
USPC 360/99.08

(57) ABSTRACT

Disclosed herein is a hard disk drive. The hard disk drive according to a preferred embodiment of the present invention includes: at least one disk; a spindle motor rotating the disk; a head stack assembly rotatable to write and read data on and from the disk; a plate-shaped base rotatably supporting the head stack assembly and supporting the spindle motor; and at least one elongated pin disposed on the base. In particular, the base according to the preferred embodiment of the present invention is integrally provided with at least one cylindrical burring part that may receive a part of the pin.

### CROSS REFERENCE TO RELATED APPLICATION

This application claims the benefit of Korean Patent Application No. 10-2013-0032154, filed on Mar. 26, 2013, entitled “Hard Disk Drive” which is hereby incorporated by reference in its entirety into this application.

### BACKGROUND OF THE INVENTION

1. Technical Field

The present invention relates to a hard disk drive.

2. Description of the Related Art

A hard disk drive (HDD) is a kind of memory device which stores data in a magnetic disk and generally includes a magnetic disk on which data are written and stored and a head stack assembly (HSA) moving a head, which writes and reads data on and from the disk, on the disk.

As widely known already, apparatuses, such as a hard disk drive or an optical disk drive (ODD), may include a magnetic disk rotatably mounted in a spindle motor and record or play data on and from the magnetic disk.

As described above, the hard disk drive is provided with a motor rotating a disk, for example, a spindle motor and requires a base for the hard disk drive in which the head stack assembly accessing the head is mounted. An example of the base for the hard disk drive is disclosed in Patent Document 1.

Patent Document 1 according to the prior art discloses that a steel plate or an aluminum plate to be used as the base suffers from pressing in order to form various curved portions thereon. There is a need to perforate a plurality of holes through which pins required to mount the head stack assembly, and the like, may stand on the pressed base.

As widely known already to a person having ordinary skill in the art to which the present invention pertains, according to the related art for manufacturing the base provided in the hard disk drive, the base is produced by a post-processing scheme of die-casting aluminum and then removing burrs that occur due to die-casting, and the like.

However, in the die-casting scheme according to the related art, in a process of injecting aluminum (Al) in a molten state in order to make a base is performed, high temperature and pressure are required, such that a large amount of energy is required in the process and process time and costs increase.

Therefore, in order to solve the problems of the die-casting process, an attempt to manufacture the base by plastic working, such as pressing, and the like, has been conducted. However, in the case of manufacturing the base by the pressing, since the base basically has a thin and uniform thickness, a problem may occur in coupling components (for example, pin, and the like) in the base.

That is, in the case of manufacturing a board having a thin, uniform thickness by the pressing, since the thickness of the base is thin, the unmating force between the base and the components cannot but be reduced when the components (for example, pins, and the like) are press-fitted in the base.

As illustrated in FIG. 1 of the Patent Document 1, the base is formed with the plurality of holes in order to mount the pins, but a separate alternative plan to ensure the unmating force between the hole of the base having a thin thickness and the pin inserted into the hole is not disclosed.

### PRIOR ART DOCUMENTS

### Patent Document

(Patent Document) Patent Document 1: Japanese Patent Laid-open Publication No. 2000-298929

### SUMMARY OF THE INVENTION

The present invention has been made in an effort to provide a structure helping press-fitting of pins in a base pressed to be used in a hard disk drive.

According to a preferred embodiment of the present invention, there is provided a hard disk drive including: at least one disk; a spindle motor rotating the disk; a head stack assembly rotatable to write and read data on and from the disk; a plate-shaped base rotatably supporting the head stack assembly and supporting the spindle motor; and at least one elongated pin disposed on the base. In particular, the base according to the preferred embodiment of the present invention is integrally provided with at least one cylindrical burring part that may receive a part of the pin.

The base may be molded and/or manufactured by plastic working, such as pressing, and the like.

The cylindrical burring part may have a hollow part formed therein and an inner circumference of an upper end of the burring part may be provided with an inclined surface tilted toward the hollow part.

The pin may include an insertion part and a rod part and the insertion part and the rod part may be partitioned by a step to have different diameters from each other.

A size of the rod part may be formed to be larger than that of the insertion part to dispose the pin over the upper end of the burring part.

A lower end of the insertion part may be rounded or chamfered to be easily guided into the hollow part of the burring part.

The hollow part of the burring part may be formed in the same size and shape as the insertion part of the pin to be inserted in a press-fitting manner.

The pin may be a latch pin for the hard disk drive.

The pin may be an IDCS pin for the hard disk drive.

The base may be integrally formed with the burring part, in particular, a connection part of the burring part extending from the base may be bent in a curved shape without being bent.

The burring part may vertically extend upward on an upper surface of the base, in detail, a mounting surface of the head stack assembly.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a hard disk drive according to a preferred embodiment of the present invention;

FIG. 2 is a plan view of a state in which pins are removed from a base illustrated in FIG. 1; and

FIG. 3 is a cross-sectional view of an arc part A of FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a hard disk drive according to preferred embodiments of the present invention will be described in detail with reference to the accompanying drawings.

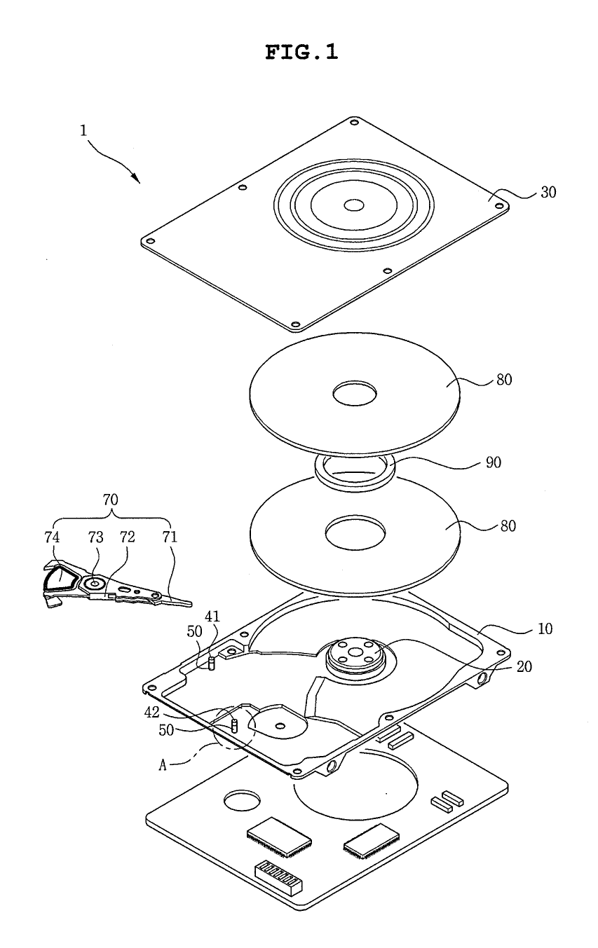

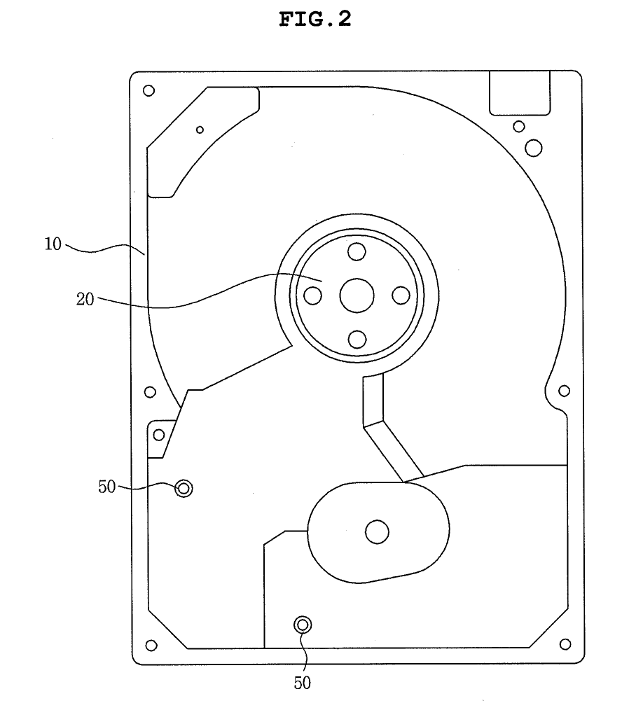

Referring to FIGS. 1 and 2, a hard disk drive 1 to which a base 10 according to a preferred embodiment of the present invention is applied includes the base 10, a spindle motor 20 rotating at least one disk 80, a cover 30, and a head stack assembly 70. In addition, in the hard disk drive 1, a printed circuit board (no reference numeral) is disposed under the base 10.

As illustrated, the base 10 has a plate shape so as to support a spindle motor 20 and a head stack assembly (HSA) 70 thereon. A cover 30 is assembled over the base 10 and protects the spindle motor 20, the HSA 70, disks 80, and the like, which are mounted on the base 10. For reference, as described above, the disk 80 is rotatably disposed by the spindle motor 20 and is generally partitioned into a parking zone and a data zone.

The spindle motor 20, which helps a regular speed rotation of the disk 80, is disposed on the base 10. Briefly, the spindle motor 20 includes a ring-shaped core fixed on the base 10, a stator configured of a coil wound around the core to generate an electric field, a rotor disposed outside the stator to generate an electric field for a rotation of a hub and rotatably disposed to the stator, and a shaft disposed on a line of a vertical axis coinciding with a rotational center of the hub.

In addition, a ring-shaped spacer 90 is disposed between a plurality of disks 80, supporting the plurality of disks 80 which are arranged on an outer circumferential surface of the hub of the spindle motor 20, thereby constantly maintaining an interval between the respective disks 80.

The head stack assembly 70 (HSA), which is rotatably fastened on the base 10, includes a head part 71, an arm part 72, a pivot part 73, and a coil part 74.

As illustrated, the HSA 70 has the pivot part 73 disposed at a center thereof and the coil part 74 disposed at the rear thereof The HSA 70 rotates by a driving means and preferably, the driving means may be a voice coil motor and includes the coil part 74 and a magnet (not illustrated) disposed to face the coil part.

According to the preferred embodiment of the present invention, in the HSA 70, the arm part 72 rotates at a predetermined angle via the driving means including the coil part 74 based on the pivot part 73 and the head part 71 may rotate on the disk 80 clockwise or counterclockwise by the rotating arm part 72.

The head part 71 of the HSA 70 serves to write data on the disk 80 or read the data from the disk 80. That is, the HSA 70 rotates based on the pivot part 73 by rotating the driving means by the coil part 74 and the head part 71 mounted in front of the arm part 72 flies at a predetermined height over the surface of the disk 80 to write or read the data on or from the disk 80.

When the hard disk drive 1 according to the preferred embodiment of the present invention in which the HSA 70 is mounted is unused, for example, the head part 71 rotates from the data zone of the disk 80 to the parking zone thereof by converting an operation mode into an off mode.

When the head part 71 enters the parking zone, the head part 71 enters beyond a central axis of the disk due to an abnormal operation, such as a malfunction, and thus collides with the spindle motor 20. In order to prevent the collision beforehand, in the hard disk drive 1 according to the preferred embodiment of the present invention, an inner disk crash stop (IDCS) pin 42 needs to be disposed in the base 10.

In addition, at the time of the power off, the rotation of the spindle motor 20 stops and the head part 71 loses a flying force and is automatically parked in the predetermined parking zone of the disk 80. In this case, when unexpected vibration or impact is applied from the outside, the head part 71 of the HSA 70 infringes on the data zone in the state in which the head part 71 contacts the disk 80 to generate a hard defect, for example, a physical bad sector, thereby damaging the data.

In order to prevent the occurrence of the problems, in the hard disk drive 1, a latch pin 41 is generally disposed on the base.

As described above, in order to limit the unnecessary movement of the HSA 70, the latch pin 41 and the IDCS pin 42 disposed around the HSA 70 is assuredly fixed on the base 10 and pressed to have a thin thickness.

Therefore, according to the preferred embodiment of the present invention, in the base 10 pressed to have a thin thickness, a cylindrical burring part 50 is formed to help stand the latch pin 41 and the IDCS pin 42.

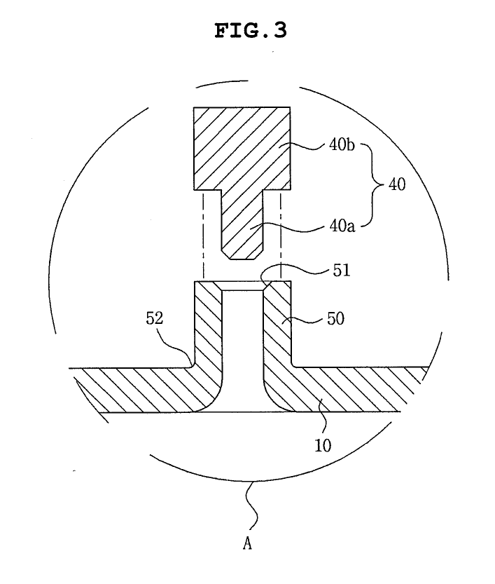

FIG. 3 is a cross-sectional view of an arc part A of FIG. 1 and to help the understanding of the preferred embodiment of the present invention, illustrates the state in which the pins 40, 41, and 42 are separated from the burring part 50 of the base 10. For clearer description, as the pin described in the detailed description of the preferred embodiment of the present invention, the latch pin 41 and the IDCS pin 42 are representatively described, but it is to be noted that the preferred embodiment of the present invention is not limited thereto and may be applied to various pins 40 press-fitted in the base 10 of the hard disk drive 1.

As described above, the base 10 according to the preferred embodiment of the present invention has a thin plate shape by the plastic working, for example, the pressing. The base 10 suffers from bending to allow the pressing to form a curved portion and suffers from burring to allow a punching apparatus to form at least one cylindrical hole (not illustrated).

The base 10 may be formed with the burring part 50 by the burring (see FIG. 1), in which the burring part 50 may receive the pin 40, for example, the latch pin 41 or the IDCS pin 42. That is, the burring part 50 is formed in a cylindrical shape to seat the pin 40 and may be integrally formed with the base 10.

The cylindrical burring part 50 helps seat the pin 40 and increases a contact area with the pin 40, thereby ensuring the coupled state of the burring part 50 and the pin 40. Further, the burring part 50 vertically extends upward on the base 10 and receives an insertion part 40a of the pin 40 vertically standing therein to improve perpendicularity of the pin 40.

Optionally, an upper end of the burring part 50 may be provided with an inclined surface 51 tilted toward the center at an inner circumference of the upper end thereof so that the insertion part 40a of the pin 40 may be easily guided into a hollow part of the burring part 50.

Further, as described above, the burring part 50 forms a hole on the base plate by the burring and vertically bends upward a material of the base plate at a right angle on the base on which the HSA is mounted. A connection part 52 between the burring part 50 and the base 10 is bent in a curved shape. The curved connection part 52 is not connected by being bent in a general bending manner to prevent the mechanical rigidity of the base of a thin material from being reduced.

For the coupling of the burring part 50 and the pin 40, the hollow part of the burring part 50 has the same size and shape of the insertion part 40a of the pin 40, and thus may be certainly press-fitted.

As illustrated, the pin 40 according to the preferred embodiment of the present invention includes the insertion part 40a and a rod part 40b. In this configuration, the insertion part 40a means a portion received into the hollow part of the burring part 50 and the rod part 40b, which is exposed to the outside while being seated on the burring part 50 to be exposed to the outside, means a portion contacting, for example, the HSA 70 to restrict the rotation movement.

The pin 40 has a step formed therearound, in which the step partitions the insertion part 40a and the rod portion 40b. The rod part 40b is formed to be larger than that of the insertion part 40a to be seated on the upper end of the burring part 50 while restricting the additional insertion into the hollow part 40a of the buffing part 50.

A lower end of the insertion part 40a is rounded or chamfered so as to easily guide the insertion part 40a of the pin 40 into the hollow part of the burring part 50. An outer diameter of the rounded or chamfered insertion part of the pin 40 is designed to be smaller than an inner diameter of the hollow part of the burring part 50 to help the position selection of the insertion part 40a into the hollow part at the time of mounting the insertion part 40a of the pin 40, thereby preventing the insertion part 40 from being separated from the burring part 50.

Preferably, the lower end of the insertion part 40a is rounded and thus may minimize the damage of the burring part 50 at the time of contacting the upper end of the burring part 50 having a thin thickness.

As set forth above, according to the preferred embodiment of the present invention, it is possible to help insert the components, for example, the pin, and the like, into the base pressed to have a thin thickness.

Further, according to the preferred embodiment of the present invention, the separate component for ensuring the holding state of the pin while securing the reliably press-fitted state of the pins by the pressing cannot be further required.

In addition, according to the preferred embodiment of the present invention, the base part can be integrally formed with the burring part by the plastic working, such as the pressing, and the like, thereby remarkably reducing man hours at the time of the manufacturing of a product and improving the durability of a product.

Although the embodiment of the present invention has been disclosed for illustrative purposes, it will be appreciated that a hard disk drive according to the invention are not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A hard disk drive, comprising:
at least one disk;
a spindle motor rotating the disk;
a head stack assembly rotatable to write and read data on and from the disk;
a plate-shaped base rotatably supporting the head stack assembly and supporting the spindle motor; and
an elongated pin,
wherein the base is integrally provided with at least one cylindrical burring part having a hollow part receiving a part of the pin.

2. The hard disk drive as set forth in claim 1, wherein the base is molded by a pressing manner.

3. The hard disk drive as set forth in claim 1, wherein the cylindrical burring part is provided with an inclined surface tilted toward the hollow part inside of an upper end thereof.

4. The hard disk drive as set forth in claim 1, wherein the pin includes an insertion part and a rod part and the insertion part and the rod part are partitioned by a step.

5. The hard disk drive as set forth in claim 4, wherein a size of the rod part is formed to be larger than that of the insertion part.

6. The hard disk drive as set forth in claim 4, wherein a lower end of the insertion part is rounded or chamfered.

7. The hard disk drive as set forth in claim 1, wherein the hollow part of the burring part is formed in the same size and shape as the insertion part of the pin.

8. The hard disk drive as set forth in claim 1, wherein the pin is a latch pin.

9. The hard disk drive as set forth in claim 1, wherein the pin is an IDCS pin.

10. The hard disk drive as set forth in claim 1, wherein a connection part of the burring part and the base are connected in a curved shape.

11. The hard disk drive as set forth in claim 1, wherein the burring part vertically extends upward on the base.
